(19) United States
(12) Patent Application Publication
(10) Pub. No.: US 2011/0144853 A1
(43) Pub. Date: Jun. 16, 2011

(54) MINING METHODOLOGY TO ELIMINATE INAPPROPRIATE SETTING OF ERROR CONDITIONS USING OPERATING PARAMETERS

(75) Inventors: Halasya Siva Subramania, Bangalore (IN); Satnam Singh, Bangalore (IN); Steven W. Holland, St Clair, MI (US); Jason T. Davis, Williamston, MI (US); Tim Felke, Glendale, AZ (US); Ravindra Patankar, Phoenix, AZ (US); Aru Narla, Chandler, AZ (US)

(73) Assignee: GM GLOBAL TECHNOLOGY OPERATIONS, INC., Detroit, MI (US)

(21) Appl. No.: 12/638,592

(22) Filed: Dec. 15, 2009

(51) Int. Cl. G06F 7/00; G01M 17/00; G06F 17/30

(52) U.S. Cl. 701/31; 707/754; 707/776; 707/E17.014

(57) ABSTRACT

A system and method for reducing or eliminating built-in tests and diagnostic trouble codes that are set as a result of improper parameter values. The method includes collecting field failure data that identifies diagnostic trouble codes and parameters of the system that are used to set diagnostic trouble codes. The method transforms the collected data into a format more appropriate for human analysis and pre-processes the transferred data to identify and remove information that could bias the human analysis. The method includes plotting linear and nonlinear combinations of operation parameters, performing data mining and analysis for detecting inappropriate settings of fault codes in the pre-processed data and providing the mined data to a subject matter expert for review to determine whether a diagnostic trouble code has been issued because of improper parameters.

### BACKGROUND OF THE INVENTION

1. Field of the Invention

This invention relates generally to a system and method for reducing or eliminating improper setting of built-in tests (BITs) and diagnostic trouble codes (DTCs) and, more particularly, to a system and method for reducing or eliminating improper BITs and DTCs that include identifying DTCs triggered under invalid conditions and preventing the DTC from being triggered under those conditions in the future.

2. Discussion of the Related Art

Modern vehicles are complex electrical and mechanical systems that employ many components, devices, modules, sub-systems, etc. that pass electrical information between and among each other using sophisticated algorithms and data buses. As with anything, these types of devices and algorithms are susceptible to errors, failures and faults that affect the operation of the vehicle. When such errors and faults occur, often the affected device or component will issue a fault code, such as diagnostic trouble code (DTC), that is received by one or more system controller identifying the fault, or some ancillary fault with an integrated component. These DTCs can be analyzed by service technicians and engineers to identify problems and/or make system corrections and upgrades. However, given the complexity of vehicle systems, many DTCs and other signals could be triggered for many different reasons, which could make trouble-shooting particularly difficult.

As mentioned above, modern vehicles have a number of mechanical and electrical parts that are in electrical communication through various controllers. If a certain actuator, sensor or sub-system is not operating properly, it, or it's controller, will typically provide a DTC that is received by a system controller, which can later be downloaded during service of the vehicle. When a new vehicle model is put into service, DTCs are typically regularly and intermittently triggered when a problem associated with that DTC does not exist. Many of these improperly triggered DTCs are a result certain parameters occurring, when those conditions should not have existed. It has been discovered during review that some parameters had abnormal values associated with a DTC of a certain vehicle component, device or sub-system. This may be the result of system initialization where the DTC may have been triggered while the vehicle system was being started or shut-down where certain values, such as voltages, would not have been read. Thus, the DTC identified a problem when none actually existed.

Because these DTCs often require the vehicle owner to take the vehicle to a service facility to investigate the problem, there is a great desire to reduced the number of improper DTCs to as low of a level as possible because of warranty and cost issues.

### SUMMARY OF THE INVENTION

In accordance with the teachings of the present invention, a system and method are disclosed for reducing or eliminating diagnostic trouble codes that are set as a result of improper parameter values. The method includes collecting field failure data that identifies diagnostic trouble codes and parameters of the system that are used to set diagnostic trouble codes. The method transforms the collected data into a format more appropriate for human analysis and pre-processes the transferred data to identify and remove information that could bias the human analysis. The method includes plotting the linear and nonlinear combinations of the operating parameters, performing data mining and analysis for detecting the inappropriate setting of fault codes in the pre-processed data and providing the mined data to a subject matter expert (SME) for review to determine whether a diagnostic trouble code has been triggered because of improper values for operating parameters.

Additional features of the present invention will become apparent from the following description and appended claims, taken in conjunction with the accompanying drawings.

### BRIEF DESCRIPTION OF THE DRAWINGS

FIG. 1 is a block diagram of a system for identifying and correcting improperly set diagnostic trouble codes;

FIG. 2 is a flow chart diagram showing a process for identifying and correcting improperly set diagnostic trouble codes; and

FIG. 3 is a graph with control module voltage on the horizontal axis and powertrain relay voltage on the vertical axis showing an example showing how the process for identifying and correcting improperly set diagnostic trouble codes occurs.

### DETAILED DESCRIPTION OF THE EMBODIMENTS

The following discussion of the embodiments of the invention directed to a system and method for identifying and correcting diagnostic trouble codes that were triggered based on improper operating parameters is merely exemplary in nature, and is in no way intended to limit the invention or its applications or uses. For example, the present invention has particular application for detecting and correcting improper diagnostic trouble codes in a vehicle. However, as will be appreciated by those skilled in the art, the method for preventing improper DTCs may have application for other systems.

DTCs are triggered in response to a certain number of vehicle parameters, such as voltages, pressures, temperatures, etc., having certain undesirable values. For some DTCs, those parameters are selected to identify a certain problem. It has been discovered that DTCs are sometimes set improperly because the proper combination of parameters has been met, but the system was not in the proper condition for the parameters to be read. For example, if a vehicle system is an initialization state, such as during start-up or shut-down, measurements from sensors may not be occurring yet. In other words, it has been discovered that sometimes DTCs are set when certain of the parameters necessary to set the DTC have a value that is not possible, such as a zero voltage. As mentioned, such a condition may occur if the voltage is not being read because it is during an initialization sequence. The present invention provides a process for detecting anomalies in DTC preconditions when the various vehicle operating parameters are in a transient state to identify and reduce intermittent DTCs that may occur when a problem is not actually happening. Such a process provides a cross-system correlation between parameter identifiers (PIDs) and DTCs. The process and methodology detects false triggers of DTCs by analyzing the correlations among PIDs and DTCs from field failure data.

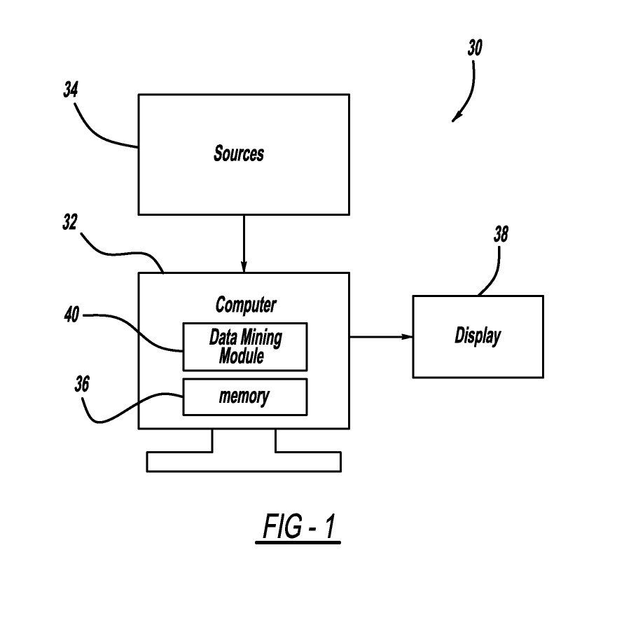

FIG. 1 is a block diagram of a system 30 that provides the necessary hardware for a proposed method for identifying and correcting improperly set diagnostic trouble codes, where the proposed process for identifying and correcting improperly set diagnostic trouble codes is performed off-board. The system 30 includes a computer 32 that is intended to represent any suitable processor that processes information received from various sources 34 that provide field failure data and parameters that are used to set diagnostic trouble codes. The sources 34 can be any source suitable for the purposes described herein, such as warranty reports, DTCs, service shop data, telematics data, etc. The information and data received by the computer 32 is stored in a memory 36 on the computer 32, which can be accessed by SMEs. The computer 32 also includes a data mining module 40 that allows for data mining and analysis to identify inappropriately set fault codes, consentient with the discussion herein. The computer 32 employs algorithms that transform the collected data into a format more appropriate for human analysis and algorithms that pre-process the transferred data to identify and remove information that could bias the human analysis from the field failure data consistent with the discussion herein. The computer 32 provides a tool that allows the SME to analyze the data and information in a suitable format, such as reports and fault models, which can be displayed on a display device 38.

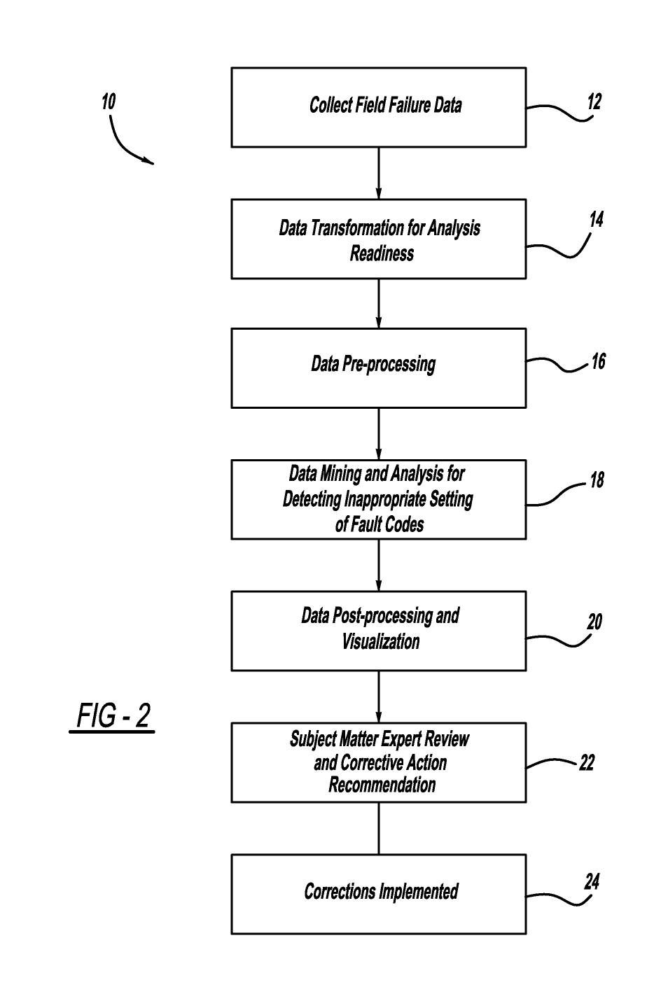

FIG. 2 is a flow chart diagram 10 showing a process for identifying and correcting improper triggered DTCs in a vehicle. Although the process being discussed herein has particular application for identifying and correcting improperly triggered DTCs for a vehicle, the process has application to other types of systems, such as the aerospace systems and devices, or any other sophisticated mechanical and/or electrical system. At box 12, field failure data is collected from vehicles that have been serviced, have warranty issues, have been inspected, etc., where a DTC has been set for one reason or another. The field failure data can include warranty claims data, DTCs, parameter identifier (PIDs), etc. from many different sources, such as service shops, telematics services, etc. The data can include what actions were taken for certain symptoms and the DTCs for warranty claims and other service occurrences, and whether those systems were affective. Collecting the field failure data may include providing DTC data in a desirable format, such as a column for DTCs, a column for PIDs, a PID description, a PID value and a PID unit. The parameters are identified by parameter identifiers (PIDs), which may indicate various operating conditions, such as voltage, current, temperature, pressure, etc., and may be made available to the service technicians. Other types of PIDs are known as developmental PIDs that are not available to the service technicians, but are only able to be viewed by engineers and other manufacturing personal during validation of the vehicle.

At box 14, the collected data is transformed into a format that is appropriate for analysis readiness. For example, the data transformation may generate many plots, graphs, chart, etc. that identify relationships between various vehicle parameters to identify the operating conditions of the vehicle for a particular vehicle system or sub-system, such as temperature, pressure, voltage, etc. These graphs, plots and charts may identify ranges for the various parameters, ratios between different parameters, differences between parameters, the existence of certain parameters, etc. At box 16, data pre-processing is performed to make the data cleaner and eliminate any data that is inappropriate for the analysis. The data pre-processing can include compensating for missing values in the data that may cause the data to be corrupted, where a shortage of buffer space may cause the loss of data.

Once the data is in a condition for analysis, the procedure provides data mining and analysis for detecting an inappropriate setting of fault codes at box 18. During the data mining and analysis, the correlation among DTCs and PIDs are analyzed by appropriate personnel so that any discrepancies and anomalies in the data can be separated for further processing. The analysis may include a determination of the existence of certain PIDs, the ratios of certain parameters, the difference of certain parameters, whether certain parameters are within a desired range of values for a certain time period, etc. based on the various plots, such as histograms, scatter plots, control charts, etc. generated by the data transformation step. The data mining and analysis process would include selectively identifying parameters and DTCs that may be applicable for certain situations, such as intermittent failures, so the amount of data can be reduced from that which is collected. The data mining and analysis may include plotting the DTCs, decision trees to reconstruct a probabilistic fault tree using PIDs and its value to trigger DTCs, etc. At box 20, the isolated data is post-processed and visualized by appropriate personnel to further refine the isolated information. For example, the post-processing may separate the isolated information into different subject matters that require different technical expertise to perform the final analysis on the data from which remedies can be provided.

Once the post-processing is complete, then the particular isolated information for a particular vehicle device, component, module, sub-system, etc. is provided to a subject matter expert at box 22 who reviews the information to determine whether that information shows any improper or impossible parameter situations that should not be occurring, which would invalidly set the particular DTC. In other words, the particular subject matter expert for the DTC or DTCs being reviewed will know if a particular parameter is not valid, a particular relationship between parameters is not valid, etc., where the DTC was either prematurely set or improperly set based on conditions that should not have been existing when the algorithms reviewed the parameters to determine whether the DTC should be set. If the subject matter expert does find such conditions, then that person can recommend corrective actions to be taken, such as provides lines of code to the algorithms that will not set the DTC if the particular relationship between the parameters does occur. That recommendation can be implemented at box 24.

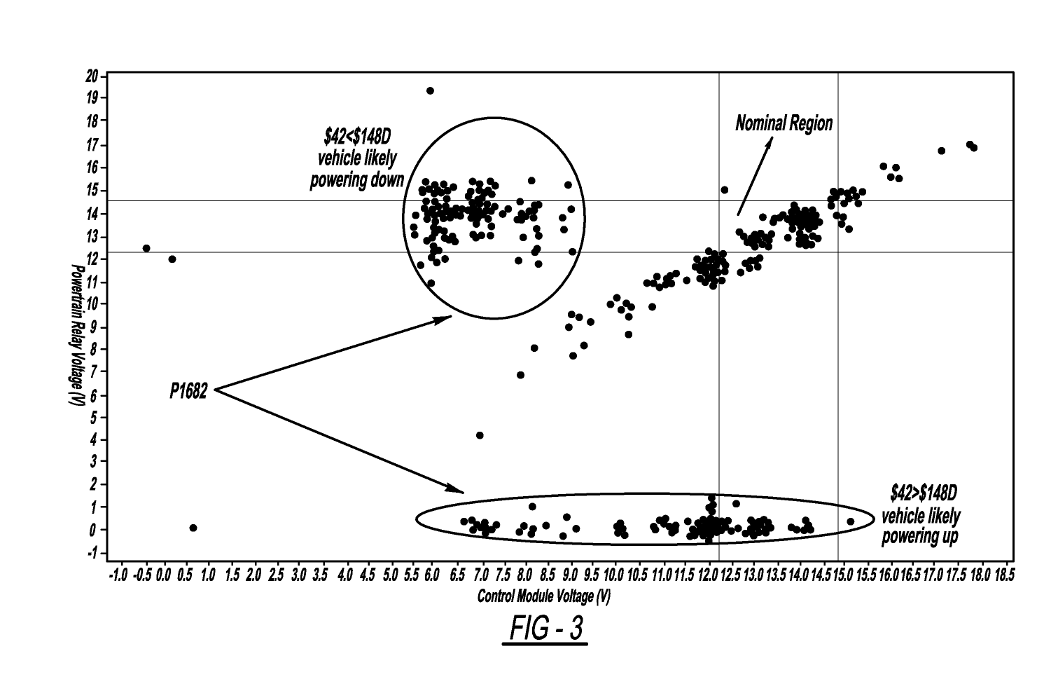

FIG. 3 is a graph with control module voltage on the horizontal axis defined by PID $0042, and powertrain relay voltage on the vertical axis defined by PID $148D as a representative example for showing how the process for reducing or eliminating improper setting of BITs and diagnostic trouble codes is performed as discussed above. Using the SME knowledge and the data mining results, PID $0042 and PID $148D were found to be the primary PIDs that affects P1682 i.e., Ignition 1, Switch Circuit 2. It can be seen in FIG. 3 that the two voltages are more or less the same for the DTCs represented by various dots along a straight line. DTC P1682's occurrences in the circled regions are far away from the “nominal” region.

After reviewing the results with SMEs, it was concluded that such extreme mismatches can occur when the engine is being turned on or off. During turn on, the control module voltage achieves a normal range almost instantaneously while the powertrain relay voltage requires a certain time to charge up determined by the time constant of the circuit. On the other hand, when the engine is switched off, the control module voltage falls to zero almost instantaneously while the powertrain relay needs some time to discharge.

The occurrence of P1682 is abnormally high for this data-set which results in expensive repairs, usually the replacement of the control module. The DTC code for P1682 is not supposed to run during the transient period of start-up and shut-down. Therefore, this finding leads to changes in the condition under which this DTC should run.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for reducing or eliminating improper error conditions in a system, said method comprising:
collecting field failure data identifying built-in tests, diagnostic trouble codes and parameters of the system that are used to set the diagnostic trouble codes;
transforming the collected data into a format more appropriate for human analysis;
pre-processing the transformed data to identify and remove information that could bias the human analysis;
performing data mining and analysis for detecting inappropriate settings of fault codes in the pre-processed data; and
providing the mined data to a subject matter expert for review to determine whether a diagnostic trouble code has been triggered because of improper values of operating parameters.

2. The method according to claim 1 wherein the parameters for a particular diagnostic trouble code include voltage, temperature and pressure.

3. The method according to claim 1 wherein transforming the collected data for analysis includes converting a chart that includes lines of information identifying diagnostic trouble codes, parameter identifier descriptions and parameter identifier values and units to a user friendly format.

4. The method according to claim 1 wherein pre-processing the transformed data includes identifying missing values and information.

5. The method according to claim 1 wherein performing data mining and analysis includes employing decision trees to reconstruct a probabilistic fault tree using parameter identifiers.

6. The method according to claim 1 wherein performing data mining and analysis includes providing plots that identify relationships between parameters and between diagnostic trouble codes and parameters.

7. The method according to claim 1 wherein providing the mined data to subject matter expert includes determining whether a particular parameter could exist for a particular system condition.

8. The method according to claim 1 further comprising data post-processing and visualization of the mined data before the data is provided to the subject matter expert.

9. The method according to claim 1 wherein the system is a vehicle system.

10. A method for reducing or eliminating improper error conditions in a vehicle, said method comprising:
collecting field failure data identifying diagnostic trouble codes and parameters of the vehicles that are used to set the diagnostic trouble codes, said parameters including one or more of voltage, pressure and temperature;
transforming the collected data into a format more appropriate for human analysis;
pre-processing the transformed data to identify and remove information that could bias the human analysis including identifying missing values and information;
performing data mining and analysis for detecting inappropriate settings of fault codes in the pre-processed data that includes employing decision trees to reconstruct a probabilistic fault tree using parameter identifiers;
providing the mined data to a subject matter expert for review to determine whether a diagnostic trouble code has been triggered because of improper values of operating parameters that includes determining whether a particular parameter could exist for a particular system condition; and
providing recommendations to adjust the setting of the diagnostic trouble code if it is determined that a particular parameter could not exist for a particular system condition.

11. The method according to claim 10 wherein transforming the collected data for analysis includes converting a chart that includes lines of information identifying diagnostic trouble codes, parameter identifiers, parameter identifier descriptions and parameter identifier values and units to a user friendly format.

12. The method according to claim 10 further comprising data post-processing and visualization of the mined data before the data is provided to the subject matter expert.

13. The method according to claim 10 wherein transforming the collected data for analysis includes converting a chart that includes lines of information identifying diagnostic trouble codes, parameter identifiers, parameter identifier descriptions and parameter identifier values and units to a user friendly format.

14. A method for reducing or eliminating improper error signals in a system, said method comprising:
collecting data identifying built-in tests, trouble codes and parameters of the system that are used to set the trouble codes;
transforming the collected data into a format more appropriate for human analysis;
performing data mining and analysis for detecting inappropriate settings of fault codes in the pre-processed data; and
providing the mined data to a subject matter expert for review to determine whether a diagnostic trouble code has been triggered because of improper values of operating parameters.

15. The method according to claim 14 further comprising pre-processing the transformed data to identify and remove information that could bias the human analysis including identifying missing values and information.

16. The method according to claim 14 wherein the parameters for a particular trouble code include voltage, temperature and pressure.

17. The method according to claim 14 wherein performing data mining and analysis includes employing decision trees to reconstruct a probabilistic fault tree using parameter identifiers.

18. The method according to claim 14 wherein performing data mining and analysis includes providing plots that identify relationships between parameters.

19. The method according to claim 14 wherein providing the mined data to a subject matter expert includes determining whether a particular parameter could exist for a particular system condition.

20. The method according to claim 14 further comprising providing data post-processing and visualization of the mined data before the data is provided to the subject matter expert.
